(19) United States
(12) Patent Application Publication
(10) Pub. No.: US 2003/0132923 A1
(43) Pub. Date: Jul. 17, 2003

(54) Combination touch-sensitive screen stylus

(75) Inventor: Cho-Kai Hu, Shin-Tien City (TW)

Correspondence Address: BACON & THOMAS, PLLC, 625 SLATERS LANE, FOURTH FLOOR, ALEXANDRIA, VA, 22314

(73) Assignee: Pro Eton Corporation, Taipei (TW)

(21) Appl. No.: 10/045,002

(22) Filed: Jan. 15, 2002

(51) Int. Cl. G09G 5/00

(52) U.S. Cl. 345/179

(57) ABSTRACT

A combination touch-sensitive screen stylus structurally designed for notebook computers, personal digital assistants., and other devices equipped with touch-sensitive screens that is comprised of a pointed cover, an outer barrel, an inner barrel, a end sleeve, and an end cover. The pointed cover is sleeved over the front extremity of the outer barrel and has a rubber tip embedded in its front extremity. The outer barrel is sleeved onto the front of the inner barrel and has a hard writing tip disposed in its front end. The inner barrel contains a pen refill cartridge that extends to its anterior section, with the end sleeve and the end cover fitted onto the rear extremity of the inner barrel. The end cover has a reset pin extending from its front end. As such, the combination touch-sensitive screen stylus of the present invention is equipped with a soft rubber tip, a hard writing tip, a pen, and a reset pin that are utilized as required by the user.

### BACKGROUND OF THE INVENTION

1. Field of the Invention

The invention herein relates to a combination touch-sensitive screen stylus, specifically an instrument designed for utilization with notebook computers, personal digital assistants, electronic dictionaries, and other processor-based electronic devices and household appliances having touch-sensitive screens, the structural design of which provides for a combination touch-sensitive screen stylus equipped with a soft rubber tip, a hard writing tip, a pen, and a reset pin.

2. Description of the Prior Art

With changes in technology, personal computers and peripherals along with portable notebook computers, personal digital assistants, cellular telephones, and other electronic and processor-based products such as global positioning systems, electronic dictionaries, and MP3 players have already become a popular means of rapidly retrieving, processing, and utilizing the latest information and news anytime and anywhere as well as enabling communications with others. Since the capabilities of such electronic and processor-based products are constantly increasing and becoming more complex and, furthermore, designs feature smart appearances and compact dimensions, keys and other mechanical controls are difficult to integrate, requiring the use of touch-sensitive screens for processing operations to achieve both small dimensions and operating convenience.

In modern living environments, many hospitals, banks, rail depots, rapid transit systems, airports, government agencies, and private organizations provide personal services such as network appointments, searching, answering, reservations, travel advisories, and other systems that utilize touch-sensitive screens to facilitate convenient and rapid user access. As such, it is apparent that the touch-sensitive screens of processor-based devices, electronic products, and household appliances are objects that people have contact with on a regular basis, while touch-sensitive screen styli have become an indispensable tool that must be carried at all times.

Conventional touch-sensitive screen designs support tap select and hand writing applications. However, most touch-sensitive screen styli only have one hard-pointed, writing tip and are incapable of providing users appropriate control. Therefore, when such hard-pointed styli are utilized, excessive pressure causes touch-sensitive screen damage. Conventional touch-sensitive screen styli are also not designed for user portability, resulting in inconvenience whenever any of the numerous touch-sensitive screen products and service systems now in use are encountered

### SUMMARY OF THE INVENTION

Therefore, the primary objective of the invention herein is to provide a combination touch-sensitive screen stylus design comprised of a pointed cover, an outer barrel, an inner barrel, a end sleeve, and an end cover. The said pointed cover is sleeved over the front extremity of the outer barrel and has a rubber tip embedded in its front extremity. The said outer barrel is sleeved onto the front of the inner barrel and has a hard writing tip disposed in its front end. The said inner barrel contains a pen refill cartridge that extends to its anterior section, with the end sleeve and the end cover fitted onto the rear extremity of the inner barrel and, furthermore, the end cover has a reset pin extending from its front end. As such, the combination touch-sensitive screen stylus of the present invention is equipped with a soft rubber tip, a hard writing tip, a pen, and a reset pin that are utilized and alternated as required by the user.

Another objective of the invention herein is to provide a combination touch-sensitive screen stylus design in which the said end cover has a reset pin disposed in its front extremity that is concealed within the end sleeve during the assembled state, but following the removal of the end cover, the said reset pin structure can be conveniently utilized to control the reset key nested in processor-based electronic products.

Yet another objective of the invention herein is to provide a combination touch-sensitive screen stylus design in which the said end cover has a suspending ring inserted in its upper extremity so that the user can place the said stylus on a chain or a key ring to facilitate convenient portability and constant availability.

### BRIEF DESCRIPTION OF THE INVENTION

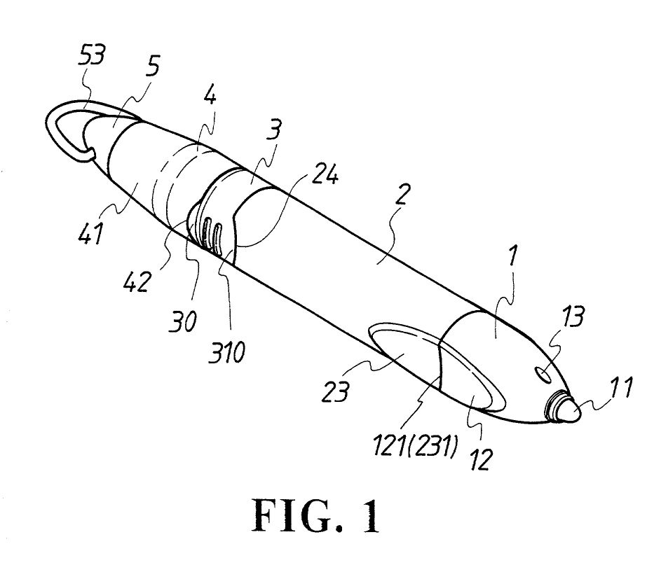

FIG. 1 is an isometric drawing of the invention herein.

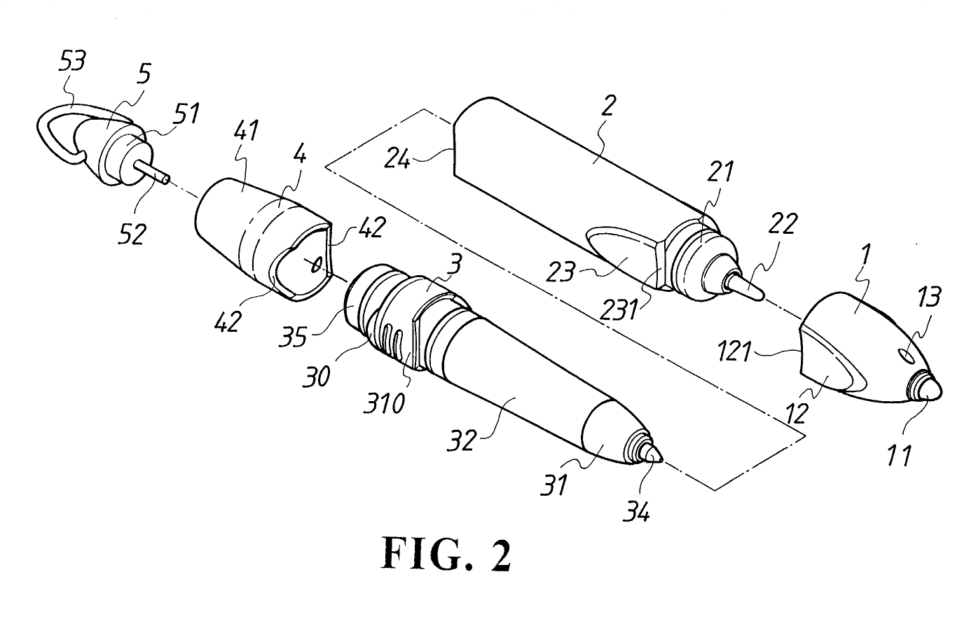

FIG. 2 is an exploded drawing of the invention herein.

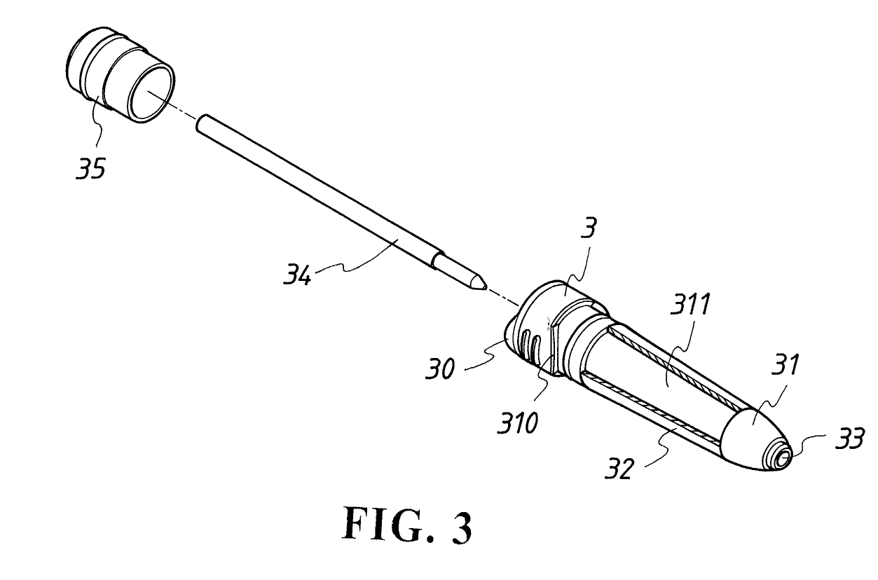

FIG. 3 is an exploded drawing of the inner barrel.

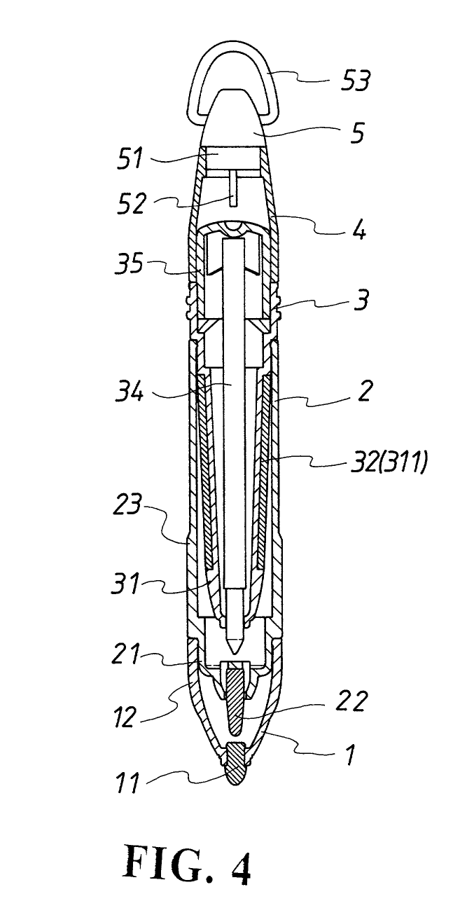

FIG. 4 is a cross-sectional drawing of the invention herein.

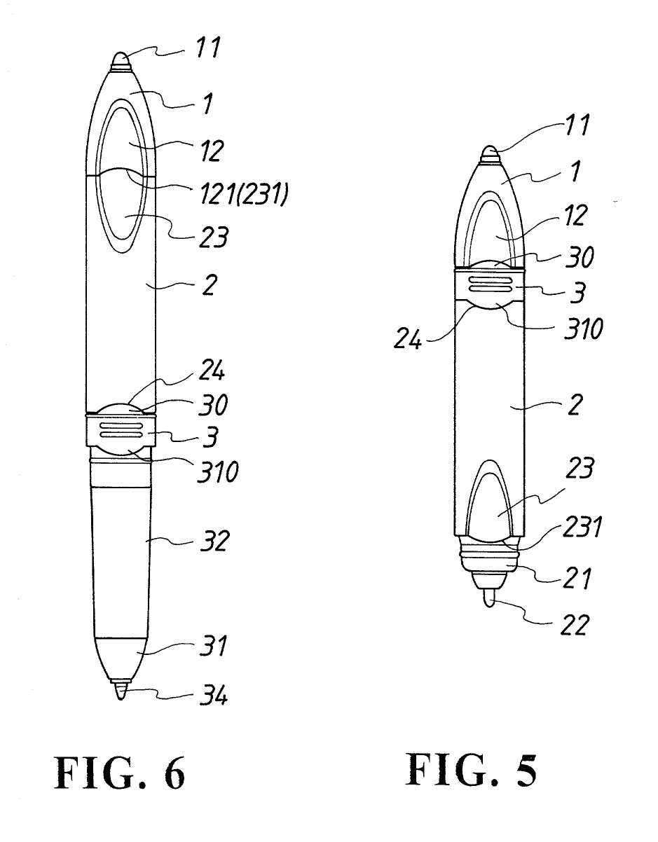

FIG. 5 is an orthographic drawing of the invention herein with the hard tip exposed for utilization.

FIG. 6 is an orthographic drawing of the invention herein with the tip of the pen refill cartridge exposed for utilization.

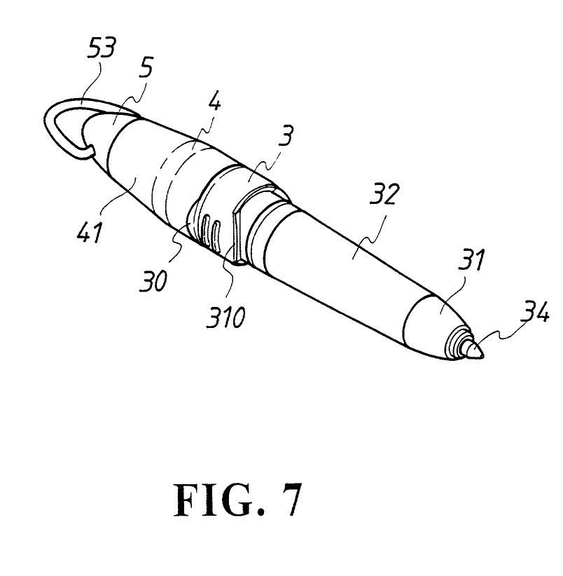

FIG. 7 is an isometric drawing of the invention herein with tip of the pen refill cartridge exposed for utilization.

### DETAILED DESCRIPTION OF THE INVENTION

Referring to FIG. 1 and FIG. 2, the combination touch-sensitive screen stylus of the invention herein is a multiple feature touch-sensitive screen implement, the design of which includes a soft rubber tip, a hard writing tip, a pen (ball point or ink, etc.), and a reset pin that provides the user a range of utilities that may be alternated as required, comprised of a pointed cover 1, an outer barrel 2, an inner barrel 3, an end sleeve 4, and an end cover 5, of which:

The pointed cover 1 is a hollow conical component sleeved onto the outer barrel 2 and consists of a columnar rubber tip 11 embedded in its front extremity that serves as a touch-sensitive screen tap and select implement, a semi-elliptical finger pad 12 disposed on two sides, a concave section 121 along the rear end of each said finger pad 12, and one or more vent holes 13 in its exterior periphery to allow air to escape when it is sleeved on.

The outer barrel 2 is a hollow tubular component with an opening in its rear extremity and consists of a protruding column 21, a sharp hard tip 22 extending from a designated area at the front end of the protruding column 21, a semi-elliptical finger pad 23 disposed on its two sides, a convex section 231 along the front end of each finger pad 23 that forms a fully ovoid construct when merged with the concave sections 121 of the pointed cap 1, and a concave section 24 along the two sides of the opening at its rear extremity.

The inner barrel 3 (as indicated in FIG. 3) is a hollow tubular component with an opening in its rear extremity and consists of a convex section 30 along the two sides of its posterior end, a tapered portion 31 of a slightly reduced diameter at its front extremity, and a convex section 310 along each of the two sides at the posterior end of the said tapered portion 31 that fits into the concave sections 24 of the outer barrel 2; the tapered portion 31 has a groove 311 formed around its exterior periphery that accommodates the slipping on of a soft tubular grip 32 and, furthermore, a hole 33 is disposed through its pointed end that provides for the insertion and emergence of a pen refill cartridge 34 at its front extremity; and a cap 35 of a cup-like profile is fitted onto the rear end of the pen refill cartridge 34 to position and enclose it.

The end sleeve 4 is a hollow cylindrical component having a reduced taper portion 41 and a concave section 42 along two sides of its lower extremity such that when the lower extremity is sleeved onto the inner barrel 3 cap 35, the said concave section 42 is secured against the convex section 30 of the inner barrel 3, following which the end cover 5 is placed onto its upper extremity.

The end cover 5 is a conic structure having a protruding column 51 at its lower extremity, a reset pin 52 extending from the end of the said protruding column 51 that provides for pushing the nested reset key of processor-based electronic products, and a suspending ring 53 mounted into its sides for placement on conventional chain-type name tags and key rings.

Given the said structural components, (as shown in FIG. 2 and FIG. 4), the rear extremity of the pointed cover 1 is sleeved over the protruding column 21 at the front extremity of the outer barrel 2 such that the hard tip 22 is enclosed and concealed inside; the rear extremity of the outer barrel 2 is sleeved onto the inner barrel 3 tapered portion 31 such that the inner barrel 3 convex sections 310 are postured against the concave sections 24 and the outer barrel 2 conceals and protects the pen refill cartridge 34; and the lower extremity of the end sleeve 4 is fitted over the area of the cap 35 on the inner barrel 3 and the protruding column 51 at the lower extremity of the said end cover 5 is inserted into the end sleeve 4; as so assembled, the combination touch-sensitive screen stylus of the present invention is equipped with a soft rubber tip 11, a hard tip 22, a pen, and a reset pin 52.

During the actual utilization of the invention herein (referring to FIG. 4), the rubber tip 11 at the front extremity of the pointed cover 1 is utilized to execute touch-sensitive screen tap selection inputs; next (as shown in FIG. 5), the end sleeve 4 and the end cover 5 are removed and then the pointed cover 1 is repositioned onto the rear extremity of the inner barrel 3 to expose the hard tip 22 at the front extremity of the outer barrel 2 for written touch-sensitive screen inputting, with the rubber tip 11 at the opposite end still available for tap selection inputs; in addition to the removability of the end sleeve 4 and the end cover 5, the outer barrel 2 can also be removed and sleeved onto the upper extremity of the inner barrel 3 or set aside elsewhere, thereby exposing the tip of the pen refill cartridge 34 for ordinary writing (as shown in FIG. 6 and FIG. 7); furthermore (referring to FIG. 2), the said end cover 5 can be independently removed to permit the utilization of the reset pin 52 to conveniently access and actuate the reset button nested in conventional processor-based electronic products. As such, the structural design of the combination touch-sensitive screen stylus of the invention herein provides the user a range of tips that can be conveniently alternated as necessary.

Furthermore, the convex sections 231, 30, and 310 and the concave sections 121, 24, and 42 on the respective structural components of the invention herein form an interlocking structure when assembled together, to disassemble, a twisting action by the user results in leverage imposed between paired convexities and concavities that results in separation, thereby providing for efficient disassembly and assembly. The design of the pointed cover 1 finger pads 12 and the outer barrel 2 finger pads 23 not only provides for comfortable user grasping, but also prevents the rolling and possible damage of the combination touch-sensitive screen stylus herein when placed down, further enhancing the practicality of the present invention.

Additionally, since the structure of the said end cover 5 includes a suspending ring 53 and the combination touch-sensitive screen stylus of the invention herein can be positioned on conventional chain-type name tags and key rings, this allows convenient user portability such that whenever a notebook computer, personal digital assistant electronic dictionary, or MP3 player as well as a hospital, bank, rail depot, mass transit system, airport, government agency or private organization service network system is encountered, the user can immediately operate the said electronic devices or networked service systems.

1. A combination touch-sensitive screen stylus comprised of a pointed cover, an outer barrel, an inner barrel, a end sleeve, and an end cover, of which:
The said pointed cover is a hollow conical component sleeved onto the extremities of the said inner and outer barrel having a rubber tip embedded in its front extremity that serves as a touch-sensitive screen tap and select implement.
The said outer barrel is a hollow tubular component with an opening in its rear extremity consisting of a protruding column and a hard tip disposed in the front end of the said protruding column.
The said inner barrel is a hollow tubular component having a tapered portion of a slightly reduced diameter at its front extremity, a hole disposed through its pointed end that provides for the insertion and emergence of a pen refill cartridge at its front extremity, and a cap fitted onto its rear end.
The said end sleeve is a hollow cylindrical component.
The said end cover is a conic structure having a suspending ring mounted in its side walls, a protruding column at its lower extremity, and a reset pin extending from the front end of the said protruding column.
As such, the said pointed cover, the said outer barrel, the said inner barrel, the said end sleeve, and the said end cover can be freely disassembled and assembled to configure a touch-sensitive screen stylus equipped with the said rubber tip, the said hard tip, the said pen refill cartridge, and the said reset pin.

2. As mentioned in claim 1 of the combination touch-sensitive screen stylus of the invention herein, the said pointed cover has a finger pad disposed on two sides and a concave section is formed along the rear end of each said finger pads.

3. As mentioned in claim 1 of the combination touch-sensitive screen stylus of the invention herein, the said pointed cover has one or more vent holes in its exterior periphery.

4. As mentioned in claim 1 of the combination touch-sensitive screen stylus of the invention herein, the said outer barrel has a finger pad disposed on its two sides and a convex section is formed along the front end of each said finger pad.

5. As mentioned in claim 1 of the combination touch-sensitive screen stylus of the invention herein, the said outer barrel has a concave section along the two sides of the opening at its rear extremity and the said opening can be sleeved over the front or rear extremities of the said inner barrel.

6. As mentioned in claim 1 of the combination touch-sensitive screen stylus of the invention herein, the said inner barrel has a convex section along each of the two sides at the posterior end of the said tapered portion.

7. As mentioned in claim 1 of the combination touch-sensitive screen stylus of the invention herein, the said tapered portion of the said inner barrel has a groove formed around its exterior periphery that accommodates the slipping on of a soft tubular grip.

8. As mentioned in claim 1 of the combination touch-sensitive screen stylus of the invention herein, the said cap fitted onto the rear extremity of the said inner barrel is of a cup-like profile.

9. As mentioned in claim 1 of the combination touch-sensitive screen stylus of the invention herein, the said inner barrel has a convex section along the two sides of its posterior end.

10. As mentioned in claim 1 of the combination touch-sensitive screen stylus of the invention herein, the said end sleeve has a concave section along two sides of its lower extremity, the lower extremity is sleeved onto the said inner barrel cap, and its upper extremity provides for the insertion of the said end cover.
